(19) United States
(12) Patent Application Publication
(10) Pub. No.: US 2007/0107025 A1
(43) Pub. Date: May 10, 2007

(54) System and method for placement of servers in an internet protocol television network

(76) Inventors: Zhi Li, San Ramon, CA (US); Canhui Ou, Danville, CA (US); Russell B. Bellford, New Berlin, WI (US); Raghvendra Savoor, Walnut Creek, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/271,230

(22) Filed: Nov. 10, 2005

(51) Int. Cl. H04N 7/173

(52) U.S. Cl. 725/97; 725/100

(57) ABSTRACT

According to one example embodiment the placement of video distribution servers and acquisition servers in a live television IPTV network is considered to be a separate process. This process may be based, for example, on historical data, number of subscribers, subscribers' service quality, some video distribution servers may be selectively placed closer to the subscribers, i.e., at some central offices or intermediate offices, instead of at the video hub office. These local video distribution servers (those video distribution servers not located at video hub office) may selectively receive popular TV channel streams just like regular video subscribers based on the multicasting protocol from the acquisition server. Whenever a subscriber wants to switch to a channel (or recover packet loss for an on-going channel), if the channel is on the popular channel list, the service may be accomplished by the local video distribution servers. Otherwise, the service will be provided by the remote video distribution servers (those placed together with acquisition servers). This approach may facilitate faster channel change and quick packet loss recovery, decreased traffic load on the service networks, and improvement in the subscribers video packets delivery performance.

### TECHNICAL FIELD

The inventive subject matter hereof relates to the field of Internet protocol television networks and more specifically to efficiently configuring an IPTV network.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2005, SBC Knowledge Ventures L.P. All Rights Reserved.

### BACKGROUND

In one proposed Internet protocol television (IPTV) network architecture, each subscriber receives live television programs in a multi-cast data stream from a video-acquisition server. Using multicast delivery, only one copy of the video programming may be sent to branch locations where the video programming may be duplicated and sent to multiple locations at the edge of the network. In addition, “instant” channel change capability is provided by video-distribution servers that distribute program content in a unicast data stream. Unicast data streams carry one copy of programming to a specific subscriber. These servers may also be used to recover video packet losses from the multicast stream to maintain acceptable quality of service. In this architecture, the video distribution servers are usually placed together with the video-acquisition servers at a video hub office. Whenever a subscriber switches to a new channel (or detects a video packet loss), the subscriber equipment contacts the video distribution servers to receive instant channel streams (or recovery packets) in a burst mode. The burst video streams from video distribution servers increase the backbone network traffic load. In addition, the video distribution servers' service latencies may also impact the subscribers' video quality.

### SUMMARY OF THE INVENTION

The inventive subject matter hereof provides system, method, and data structure for efficiently configuring an IPTV network.

### BRIEF DESCRIPTION OF THE DRAWINGS

FIGS. 1, 2 and 3 illustrate an IPTV network in accordance with one example embodiment of the inventive subject matter hereof; and

FIG. 4 illustrates a flow chart of a method for locating servers according to one example embodiment of the inventive subject matter hereof.

### DETAILED DESCRIPTION

In the following detailed description, reference is made to the accompanying drawings that form a part hereof, and in which are shown by way of illustration specific embodiments in which the inventive subject matter can be practiced. It is understood that other embodiments may be utilized and structural changes may be made without departing from the scope of the present invention. The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

According to one example embodiment, described in more detail below, the placement of video distribution servers and acquisition servers in a live television IPTV network is considered to be a separate process. This process may be based, for example, on historical data, number of subscribers, subscribers' service quality, some video distribution servers may be selectively placed closer to the subscribers, i.e., at some central offices or intermediate offices, instead of at the video hub office. These local video distribution servers (those video distribution servers not located at video hub office) may selectively receive popular TV channel streams just like regular video subscribers based on the multicasting protocol from the acquisition server. Whenever a subscriber wants to switch to a channel (or recover packet loss for an on-going channel), if the channel is on the popular channel list, the service may be accomplished by the local video distribution servers. Otherwise, the service will be provided by the remote video distribution servers (those placed together with acquisition servers). This approach may facilitate faster channel change and quick packet loss recovery, decreased traffic load on the service networks, and improvement in the subscribers video packets delivery performance.

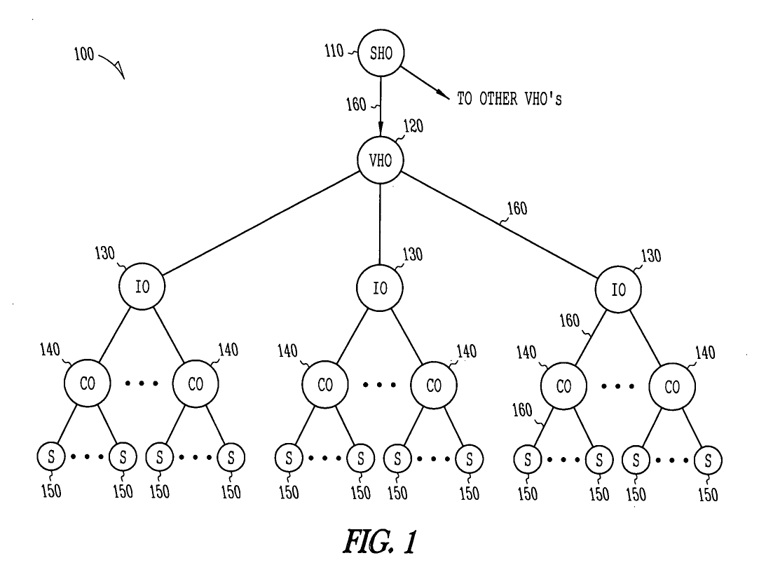

Referring now to FIGS. 1, 2 and 3 illustrate a first example embodiments of the inventive subject matter hereof will be described in more detail. FIGS. 1, 2 and 3 are schematic diagrams depicting a configuration of an IPTV network 100 in accordance with one embodiment of the inventive subject matter hereof. As shown in FIG. 1, the network 100 includes a super hub office (SHO) 120 for acquisition and encoding of video content, one or more video hub offices (VHO) 120 in each demographic market area (DMA), one or more intermediate offices (IO) 130, one or more central offices (CO) 140 located in each metropolitan area, and finally the subscribers (S) 150, which may be located in single or multiple dwelling units. In one example embodiment, the network 100 may be connected through a plurality of high speed communication links 160 using physical transport layers such as fiber, cable, twisted pair, air or other media.

In one example embodiment, of the IPTV video delivery system, the SHO 110 distributes content to the VHOs 120 which may be spread across the a wide geographic territory, such as an entire country. In one example IPTV network configuration, the SHO 110 may be in a central location for acquisition and aggregation of national-level broadcast TV (or linear) programming. A redundant SHO 110 may be provided for backup in case of failure. The SHO 110 may also the central point of on-demand content acquisition and insertion into the IPTV network. Linear programming may be received at the SHO 110 via satellite and processed for delivery to the VHOs 120. On demand content may be received from various sources and processed/encoded to codec and bit-rate requirements for the communication network for transmission to the VHOs 120 over the high speed communication links. VHOs 120 are the video distribution points within each demographic market area (DMA) or geographic region.

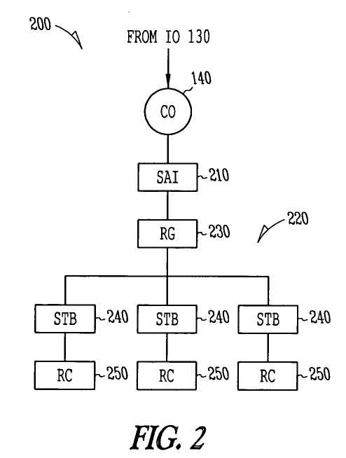

Referring now to FIG. 2, there is illustrated in more detail an example network architecture 200 between the CO 140 and the subscriber 150. A serving area interface (SAI) 210 is connected to the CO 140. SAI 210 may, for example, be located in a weather-proof enclosure proximate the subscriber premises, and may include FTTN equipment. FTTN equipment may also be located in the CO 140. Customer premise equipment (CPE) 220 includes, for example, a network interface device (NID) and a residential gateway (RG) 230, for example with a built-in VDSL modem or optical network termination (ONT). In both cases the RG 230 may be connected to the rest of the home set top boxes (STBs) 240 via an internal network such as an Ethernet. Each STB 240 has an associated remote control (RC) 250 which provides data entry to the STB 240 to control the IPTV selections from the IPTV data streams.

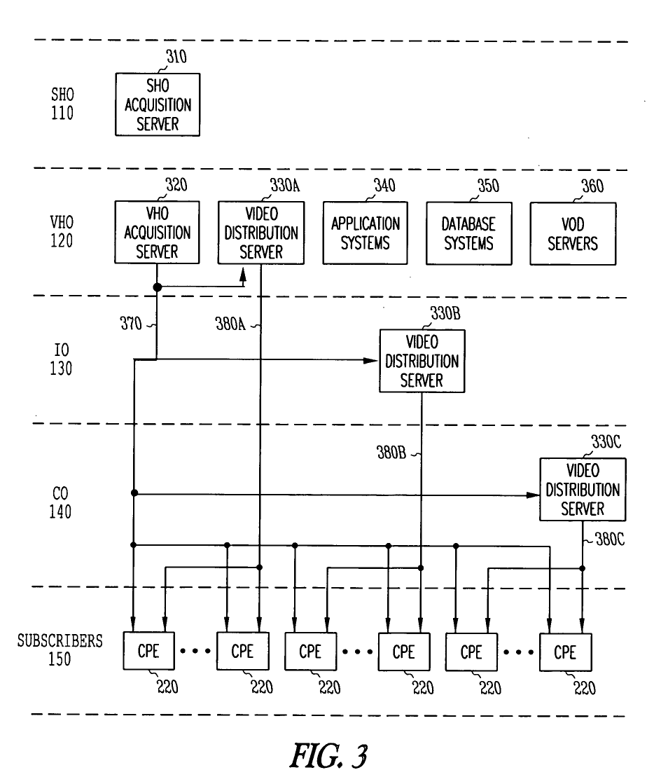

Referring now to FIG. 3, there is shown an example embodiment of placement of video distribution servers 330a, 330b and 330c in an IPTV system according to the inventive subject matter hereof. As illustrated, a SHO acquisition server 310 may be used to acquire national content that may be distributed towards the VHOs 120. In an alternative embodiment, live television content may be acquired using an acquisition server in the VHOs 120.

In one example embodiment, the VHO 120 includes a live television acquisition server 320, which forwards the live television and/or other content toward the subscriber through the intermediate offices (IOs) 130 and the central office (CO) 140 in a multicast data stream 370. The routers, switches and other network elements that would normally be present in the IOs 130 and COs 140 are not shown in FIG. 3 in order to simplify the drawing. The number of programs or channels sent in the multicast stream may, without limitation, range up to 800 channels or more using present technology with it being understood that advances in technology may allow many more channels to be sent. The multicast protocol allows for efficient distribution of these signals to a large number of end subscribers.

A video acquisition server 330a is also positioned at the VHO 120, and distributes live television to subscribers 150 using unicast data streams 380. In addition, for example, two additional video distribution servers 330b and 330c are positioned, respectively, in an IO 130 and a CO 140. In this embodiment, the video distribution servers 330a, 330b and 330c may all receive the multicast data stream 370 and distributes selected ones of the live television signals, extracted from the stream 370, using unicast data streams 380a, 380b and 380c, to specific subscribers 150. In this embodiment, however, each video distribution server 330a, 330b and 330c may be configured to serve unicast data streams to a subset of the total number of subscribers served by the VHO 120. For instance, video distribution server 330a may serve subscribers 150a and 150b, video distribution server 330b may server subscribers 150c and 150d, video distribution server 330c may server subscribers 150e and 150f.

In another example embodiment, a VHO 120 may also include application systems 340, regional subscriber database systems 350, and video-on-demand (VOD) servers 360. The COs 140 are connected to the IOs 130 to further distribute traffic towards the subscribers 150. Traffic may reach the subscribers 150 at least partially via either fiber to the node (FTTN) or fiber to the premises (FTTP), or by other types of transmission medium.

Thus, in one example embodiment, each subscriber 150 receives live television programs from the video-acquisition server 320 based on IP-based multicasting services, while the video-distribution servers 330 are used to provide subscribers “instant” channel change and recover video packet losses to maintain acceptable quality of service. Further, in such an architecture, the video distribution server's service quality greatly affects the performance of the system's ability to deliver live television programs to individual subscribers.

In addition, in one configuration, the video distribution servers 330 are usually placed together with the video-acquisition servers 320 at the VHO 120. Whenever a subscriber switches to a new channel (or detects a video packet loss), it needs to contact the video distribution servers 330 to receive instant channel streams (or recovery packets). As opposed to the acquisition servers 320, which send all the video packets based on multicast, video distribution servers 330 provide services based on unicast. The burst video streams from video distribution servers 330 will necessarily increase the backbone network traffic load. In addition, the video distribution servers' 330 service latencies will also impact the subscribers' video quality.

As described further below, there is provided in one example embodiment a multi-tier architecture to place and connect all the video distribution servers 330. By considering the subscribers' video service quality, channel popularity, and video distribution server service capacity, the servers 330 can be placed so as to attempt to enable fast channel change and quick packet loss recovery, decrease the traffic load on the service networks, and improve the subscribers' video packets delivery performance.

Thus, according to one example embodiment, the placement of video distribution servers 330 and the acquisition servers 320 is considered to be a separate process. Based, for example, on historical data, number of subscribers, subscribers' service quality, some video distribution servers 330 are selectively placed closer to the subscribers, i.e., at some COs 140 or IOs 130 instead of the VHO 120. These local video distribution servers 330 (those video distribution servers not located at VHO) may selectively receive popular TV channel streams just like regular video subscribers based on the multicasting protocol from the acquisition server 320. Whenever a subscriber wants to switch to a channel (or recover packet loss for an on-going channel), if the channel is on the popular channel list, the service may be accomplished by the local video distribution servers 330. Otherwise, the service will be provided by the remote video distribution servers 330 (those placed together with acquisition servers 320).

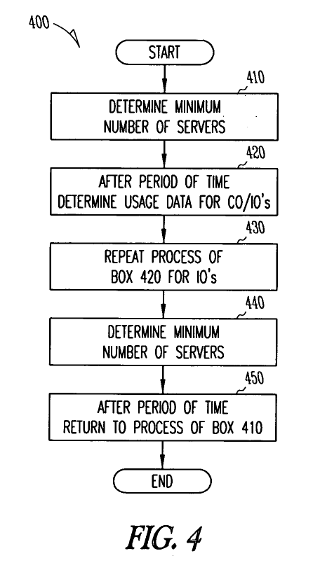

Referring now to FIG. 4, there is illustrated a process or method 400 for determining the placement of video distribution servers 330. In one example embodiment, the method for placement and adjustment of the local video distribution servers 330 may consider the number of subscribers at each region, the subscribers' existing service quality, popularity of IPTV channels, video distribution server capacity, and other factors.

As represented by flow chart box 410, the method 400, in one example embodiment, determines a minimum number of required video distribution servers 330 and places them together with the acquisition servers 320 at a VHO 120. The number of desirable video distribution servers 330 can be derived based on the existing M/M/m queuing theory. The constraints are: the predicted subscriber size, average number of channel changes per unit time per subscriber size, average number of channel changes per unit time per subscriber, packet loss probability, video distribution servers 330′ average concurrent service capacity, and the maximal permissible queuing delay (D_{Q}) for each request.

As represented by flow chart box 420, the method 400, in one example embodiment, after some time period from the initial placement represented by box 410 above, based on historical data, the average number of instant channel changes and packet loss recovery requests originated from each CO 140 and/or IO 130 is determined. As represented by flow chart box 420, the method 400, in one example embodiment, for each CO 140, the method may:
a. Choose the top N popular channels for this CO 140 (N is the number channels each video distribution server can serve).
b. Check the past customers' video quality complaints (Or historical video service quality measurement results) from this CO 140 (it is mainly because of path loss rate or delay).
c. If the number of complains from this CO 140 is over some arbitrary threshold, update the value of maximal permissible queuing delay (D_{Q}) for each packet loss recovery request in proportion to the number of complaints (m). That is, D_{Q}=D_{Q}−α*m.
d. Using M/M/m queuing theory, determine the number of required video distribution servers 330 for the N popular channels in this CO 140.
e. If the number of required video distribution servers 330 is over one and the total cost till now is below a threshold, place the corresponding number of video distribution servers 330 at this CO 140.
f. If the number of required video distribution servers 330 is less than one and it already has video distribution servers 330 placed, remove the video distribution server 330.

As represented by flow chart box 430, the method 400, in one example embodiment, for each IO 130, considers the downstream COs 140 video distribution servers 330 service capacity for the IO 130, repeat the process represented in box 420 as described above, and place or remove the necessary video distribution servers 330 at each IO 130.

As represented by flow chart box 440, the method 400, in one example embodiment, repeats the process represented by box 410, and adjust (if needed) the number and locations of remote video distribution servers 330 from a VHO while considering the VHO's downstream video distribution servers 330 capacity (those located at IOs 140 and COs 140s).

As represented by flow chart box 450, the method 400, in one example embodiment, after some period of time, returns to the process represented by box 420.

In one example embodiment, the empirical data used for the purpose of the above described method may be obtained through the use of monitoring hardware of software disbursed throughout the network 100. For example, a type of data collection and monitoring technology that may be adapted for the subject method and system is disclosed in U.S. patent application entitled “Algorithm for Optimal Video Server Placement and Video Content Aggregation/Distribution in a Switched IP Network”, filed X date, and assigned to SBC Knowledge Ventures L.P.

Thus, according to the various example embodiments described above, the systems and method of the inventive subject matter can gradually and dynamically place the video distribution servers 330 in advantageous locations based on existing video service quality, shorter distance, popularity of video channels, and the number of subscribers. Thus, one or more embodiments of the above described system and method address two potential reasons can cause IPTV service degradation: long channel change latency and video quality degradation. For the first case, shortening video distribution server 330 service time (putting the video distribution servers 330 close to subscribers and reducing the service time) will quickly fill the subscribers with video packets for the new channels and achieve instant channel changes. Also, video packet loss is one of the main reasons for video service degradation. Shortening video distribution server 330 service time not only can quickly recover video packet loss, but also can increase the number of packet recovery requests in short time. Improving these factors should provide for enhancement of subscribers' video service quality. Also, the local video distribution servers 330 can receive the live TV video traffic in the same way as regular video subscribers, so it can eliminate the burst traffic caused by instant channel change and packet loss recovery between VHO 120, IOs 130 and COs 140. The traffic from acquisition server to an IO 130 and CO 140 area network may be more stable and predictable. This may also improve the traffic engineering performance, which will potentially improve the video service quality. In addition, a multi-tier distributed video distribution server architecture can avoid the center point video distribution server failure at VHO 120 and improve the reliability of IPTV video service.

In accordance with still another example embodiment, the above described system and method may be applied to determine the location of VOD (video-on-demand) servers 360. For instance, but not by way of limitation, VOD servers 360 may be positioned at the VHOs 120, the ICOs 130 or the COs 140 in accordance with the same principles and process as described for the video distribution servers 330.

Further, in accordance with various embodiments of the inventive subject matter hereof, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the inventive subject matter hereof as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives may be considered a distribution medium equivalent to a tangible storage medium. Accordingly, the invention may be considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention may be not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Although the inventive subject matter has been described with reference to several example embodiments, it may be understood that the words that have been used are words of description and illustration, rather than words of limitation. Changes may be made within the purview of the appended claims, as presently stated and as amended, without departing from the scope and spirit of the inventive subject matter in all its aspects. Although the inventive subject matter has been described with reference to particular means, materials and embodiments, the inventive subject matter is not intended to be limited to the particulars disclosed; rather, the subject matter extends to all functionally equivalent structures, methods, and uses such as are within the scope of the appended claims.

What is claimed is:

1. A system comprising:
at least one subscriber system receiving a multicast data stream containing live television programming content from a first server positioned at a first location remote from the at least one subscriber system;
the at least one subscriber system further receiving a unicast data stream containing live television programming from a second server positioned at a second location remote from the at least one subscriber system; and
wherein the first location and the second location are different, and the second location is chosen at least in part to improve the performance of delivery of television programming to subscribers.

2. A system according to claim 1 further including a third server co-located with the first server.

3. A system according to claim 2 further including at least one additional server to distribute a unicast stream located at a third location remote from the at least one subscriber system and not co-located with either the first or second servers.

4. A system according to claim 2 wherein the second server is positioned in closer proximity to one or more of the subscribers serviced by the first server system than the third server.

5. A system according to claim 2 further wherein the second server is positioned in accordance with one or more rules related at least in part on the ability of the third server to deliver a television feed to the subscribers.

6. A method comprising:
configuring an initial state of an internet protocol television (IPTV) network having a plurality of video distribution servers used to deliver live programming in a unicast data stream;
determining at least some network activity of the initial state of the IPTV network; and
configuring the IPTV network to a secondary state by adding at least one video distribution server based on at least some of the determined network activity.

7. A method according to claim 6 further including:
establishing the initial state of the network by a) positioning a first server system to generate a multicast IP data stream carrying a video-on-demand feed to a first set of subscribers and b) positioning a second server system to generate a unicast video-on-demand IP data stream carrying a video-on-demand feed to one or more of the first set of subscribers.

8. A method according to claim 7 further wherein the first and second server systems are co-located in the initial state.

9. A method according to claim 7 further wherein the added at least one video server is positioned in accordance with one or more rules related at least in part on the ability of the second server to deliver a television feed to the subscribers.

10. A system comprising:
at least one subscriber system receiving a multicast data stream containing live television programming content from a first server positioned at a first location remote from the at least one subscriber system;
the at least one subscriber system further receiving a unicast data stream containing video-on-demand programming from a second server positioned at a second location remote from the at least one subscriber system; and
wherein the first location and the second location are different, and the second location is chosen at least in part to improve the performance of delivery of television programming to subscribers.

11. A system according to claim 10 further including a third server co-located with the first server.

12. A system according to claim 11 further including at least one additional server to distribute a unicast stream of video-on-demand programming located at a third location remote from the at least one subscriber system and not co-located with either the first or second servers.

13. A system according to claim 11 wherein the second server is positioned in closer proximity to one or more of the subscribers serviced by the first server system than the third server.

14. A system according to claim 11 further wherein the second server is positioned in accordance with one or more rules related at least in part on the ability of the third server to deliver a television feed to the subscribers.

15. A method comprising:
configuring an initial state of an internet protocol television (IPTV) network having at least one video-on-demand server used to deliver video-on-demand programming in a unicast data stream;
determining at least some network activity of the initial state of the IPTV network; and
configuring the IPTV network to a secondary state by adding at least one video-on-demand server based on at least some of the determined network activity.

16. A method according to claim 15 further including:
establishing the initial state of the network by a) positioning a first server system to generate a multicast IP data stream carrying a live television programming IP data stream to a first set of subscribers and b) positioning a second server system to generate a unicast video-on-demand IP data stream carrying a video-on-demand feed to one or more of the first set of subscribers.

17. A method according to claim 16 further wherein the first and second server systems are co-located in the initial state.

18. A method according to claim 16 further wherein the added at least one video-on-demand server is positioned in accordance with one or more rules related at least in part on the ability of the second server to deliver a television feed to the subscribers.
